(19) United States
(12) Patent Application Publication
(10) Pub. No.: US 2001/0010268 A1
(43) Pub. Date: Aug. 2, 2001

(54) Hydraulic impulse rotary tool

(75) Inventors: Manabu Tokunaga, Toyoake-shi (JP); Junichi Masuda, Okazaki-shi (JP)

Correspondence Address: LAHIVE & COCKFIELD, 28 STATE STREET, BOSTON, MA, 02109, US

(73) Assignee: Makita Corporation

(21) Appl. No.: 09/767,936

(22) Filed: Jan. 23, 2001

(30) Foreign Application Priority Data
Jan. 28, 2000 (JP) 2000-20059

(51) Int. Cl. B25D 9/00

(52) U.S. Cl. 173/205; 173/93

(57) ABSTRACT

In a hydraulic impulse screwdriver (1), a hammer (13) includes axial grooves (14) formed in the inner side wall thereof, and a spindle (11) includes V-shaped cam grooves (15) formed in the outer side wall thereof. A plurality of balls (16) are disposed in the space between the axial grooves and the opposing cam grooves. The screwdriver additionally includes a coil spring (17) for biasing the hammer (13) in a forward direction. The hammer is coupled to an anvil (19) by means of engaging recesses (18) of the hammer and engaging teeth (21) of the anvil so as to rotate integrally with the anvil. The anvil is firmly connected to a main body (24) of a hydraulic unit (23).

This application claims priority on Japanese Patent Application No. 2000-20059 filed on Jan. 28, 2000, the contents of which are incorporated herein by reference.

### BACKGROUND OF THE INVENTION

1. Field of the Invention

The present invention relates to hydraulic impulse rotary tools, such as, hydraulic impulse screwdrivers and hydraulic impulse wrenches, which employ a hydraulic impulse generator for intermittent production of high torque.

2. Description of the Related Art

A typical hydraulic impulse rotary tool includes in a housing which contains a motor, a reduction unit, and a hydraulic impulse generator to which the torque of the motor is transmitted via the reduction unit for intermittently producing large instantaneous torque to the tool's output shaft. In such a rotary tool, as the reduction unit is directly coupled to the hydraulic impulse generator, the impact generated at the occurrence of a hydraulic impulse is directly transmitted to the reduction unit, thus causing wear and other types of damage to the gears as well as making the use of the tool uncomfortable for the operator. Various attempts have been made to address these problems. Accordingly, Japan Published Unexamined Patent Application No. 7-31281 discloses an impact absorbing mechanism which includes an epicycle reduction unit having a rotatable internal gear. The mechanism further includes a pressure member abutting the internal gear and biasing means, such as a coil spring, for urging the pressure member onto the internal gear so as to hold the gear against rotation. When a load in excess of the biasing force of the coil spring is applied to the epicycle reduction unit and other elements of the tool, the mechanism permits free rotation of the internal gear relative to the pressure member, thus absorbing the impact applied to the epicycle reduction unit.

While this impact absorbing mechanism achieves its intended objective, it suffers from certain deficiencies that reduce its utility. In the foregoing mechanism, for example, either the pressure member or the internal gear includes seating grooves formed therein each having inclined side surfaces, whereas the other one of the two elements (the pressure member and the internal gear) includes balls partially mounted therein for fitting in the seating grooves to couple the two elements. When a large load is applied, the balls ride over the inclined side walls of the seating grooves, thus allowing free rotation of the internal gear. Due to this operation principle, the workable ranges of the depth of the seating grooves and the angle of the inclined side walls are rather small, providing limited flexibility in setting the degree of shock absorbing effect. Furthermore, the biasing force of the coil spring has only the one function of securing the internal gear against rotation.

### SUMMARY OF THE INVENTION

In view of the above-identified problems, an important object of the present invention is to provide a hydraulic impulse rotary tool that provides effective shock absorption and has a high degree of flexibility in setting the degree of shock absorption.

Another object of the present invention is to provide a hydraulic impulse rotary tool in which the coil spring for shock absorption can also be used to increase the output torque of the rotary tool so as to improve the energy efficiency of the tool.

The above objects and other related objects are realized by the invention, which provides a hydraulic impulse rotary tool comprising: a housing; a motor encased within the housing for generating torque; a reduction unit with a coaxial spindle, the reduction unit being encased within the housing and adapted for receiving the torque of the motor; a hydraulic impulse generator encased within the housing and disposed coaxially with and forward of the reduction unit, the hydraulic impulse generator receiving the torque from the spindle; and a coupler disposed between the spindle and the hydraulic impulse generator in such a manner as to be coaxially rotatable with the hydraulic impulse generator and movable in the axial direction, with the spindle being loosely inserted into the coupler. The rotary tool further comprises means for biasing the coupler toward the hydraulic impulse generator; and a plurality of balls fitted in both an outer surface of the spindle and an inner surface of the coupler, one of the outer surface and the inner surface including a plurality of cam grooves therein where the balls are fitted in, the cam grooves being slanted relative to the axis of the spindle. In this apparatus, when a difference in rotational speed develops between the spindle and the coupler, the balls are moved along the respective cam grooves so as to enable rearward movement of the coupler and free rotation of the spindle.

This hydraulic impulse rotary tool can buffer the impact at the occurrence of each hydraulic impulse and prevent transmission of recoil to the reduction unit and the motor. This minimizes wear of the tool's internal mechanisms and prevents burning out of the motor as well as improve the degree of comfort experienced in holding the hydraulic impulse rotary tool. In addition, as the impact accumulated as energy in the biasing means can be released in a timely manner, the output torque increases at the occurrence of each hydraulic impulse so as to enhance the energy efficiency of the tool and reduce the power consumption. In order to buffer impacts, the cam grooves, the balls, and other associated elements/structures are provided between the spindle and the hammer in the rear of the hydraulic unit, instead of the internal gear being used for buffering of the impact. One advantage of this arrangement is that the lead of the cam grooves and/or the stroke of the coupler can be easily adjusted, thus increasing the flexibility in setting the degree of shock absorbing effect.

According to one aspect of the present invention, the coupler includes a hammer and an anvil coaxial with the hammer, with the hammer being penetrated by the spindle and provided between the motor and the anvil, and with the anvil being provided between the hammer and the hydraulic impulse generator and firmly secured on one end thereof to the hydraulic impulse generator. The rotary tool further comprises means for engaging the hammer with the anvil in such a manner as to allow axial sliding motion of the hammer relative to the anvil without disengagement from the anvil and to further allow integral rotation of the hammer with the anvil regardless of the slide position of the hammer.

According to another aspect of the present invention, the cam grooves are provided in the spindle and a plurality of axial grooves is provided in the hammer, with each axial groove generally opposing one cam groove such that one of the balls is accommodated in the space defined between a cam groove and the opposing axial groove.

According to still another aspect of the present invention, the rotary tool has two cam grooves. Each groove is generally V-shaped with a bend and two slanted groove portions, and with the bend pointing to the hydraulic impulse generator.

According to yet another aspect of the present invention, the balls are located at the bends of the respective V-shaped cam grooves while the spindle and the coupler are rotating in the same speed, and when a difference in rotational speed develops between the spindle and the coupler, the balls are moved along one of the slanted groove portions away from the bends so as to allow rearward movement of the hammer and free rotation of the spindle. Furthermore, when the difference rotational in speed is eliminated, the biasing force of the means for biasing moves forward the hammer and restores the balls to the respective bends, thus augmenting the torque of the motor.

According to one feature of the present invention, the means for biasing is a coil spring disposed between the reduction unit and the hammer for biasing the hammer toward the anvil and the hydraulic impulse generator.

In one embodiment, the coupler is rotatably supported within the housing. As the coupler is supported within the housing, smooth operation is ensured with virtually no axial runout occurring in the coupler.

According to one aspect of the present invention, the hydraulic impulse rotary tool further comprises a needle bearing for rotatably supporting the coupler within the housing.

In another aspect, the coupler includes an anvil having a generally cylindrical shape with an opening facing the motor and a hammer inserted into the anvil through the opening.

In still another aspect of the invention, the anvil includes a plurality of grooves axially extending in an inner surface thereof and the hammer includes a plurality of recesses axially extending in an outer surface thereof and generally opposing the inner surface of the anvil so as to define a plurality hollow spaces therebetween. In addition, the rotary tool further comprises at least one ball fitted in each hollow space so as to allow axial slide of the hammer relative to the anvil and integral rotation of the hammer with the anvil regardless of the slide position of the hammer.

To carry out the invention in one preferred mode, the hydraulic impulse rotary tool is one of a hydraulic impulse screwdriver and a hydraulic impulse angle wrench.

Other general and more specific objects of the invention will in part be obvious and will in part be evident from the drawings and descriptions which follow.

### BRIEF DESCRIPTION OF THE ATTACHED DRAWINGS

For a fuller understanding of the nature and objects of the present invention, reference should be made to the following detailed description and the accompanying drawings, in which:

FIG. 1 is a partially cross-sectional side elevation of an essential part of a hydraulic impulse screwdriver 1 in accordance with the present invention, shown with part of its casing removed to expose internal mechanisms;

FIG. 2 is a partially cross-sectional side elevation of the hydraulic impulse screwdriver 1 of FIG. 1, showing the operation of the internal mechanisms when a hydraulic impulse is generated;

FIG. 3 shows a partially cross-sectional side elevation of an essential part of a hydraulic impulse angle wrench 30 in accordance with the present invention, shown with part of its casing removed to expose internal mechanisms;

FIG. 4 is a cross section of the hydraulic impulse angle wrench 30 of FIG. 3, showing its hammer and anvil; and

FIG. 5 is a partially cross-sectional side elevation of the hydraulic impulse angle wrench 30 of FIG. 3, showing the operation of the internal mechanisms when a hydraulic impulse is generated.

### DETAILED DESCRIPTION OF THE PREFERRED EMBODIMENTS

Preferred embodiments according to the present invention will be described hereinafter with reference to the attached drawings.

First Embodiment

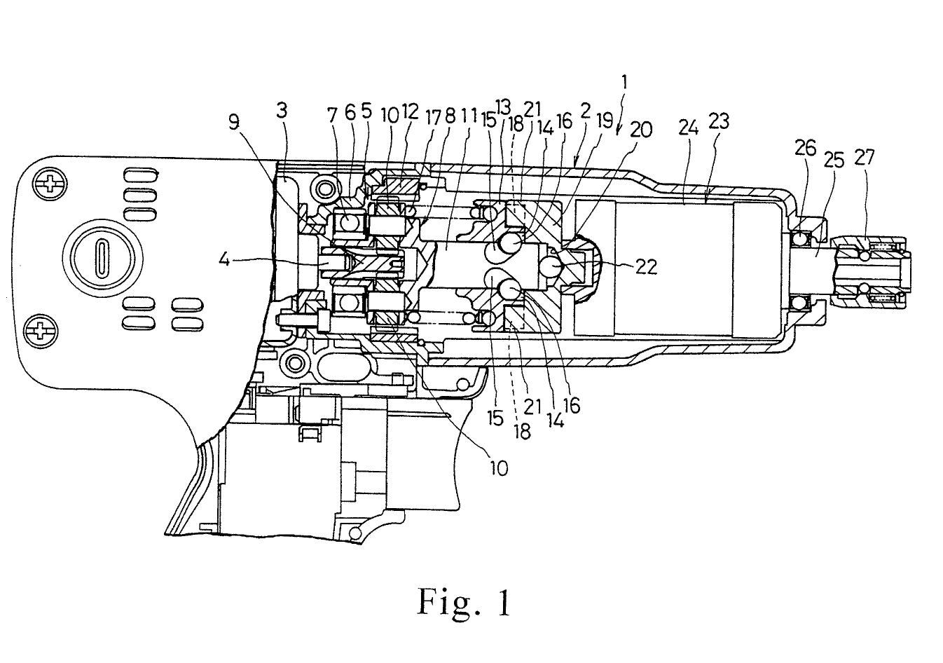

FIG. 1 is a partially cross-sectional side elevation of an essential part of a hydraulic impulse rotary tool, more particularly, a hydraulic impulse screwdriver 1 in accordance with the present invention, shown with part of its casing removed to expose internal mechanisms. The hydraulic impulse screwdriver 1 is encased in a housing 2. A motor 3 is contained within the housing 2 at the rear end of the tool 1 (the left of FIG. 1 is hereafter referred to as the rear). Provided forward of the motor 3 is an epicycle reduction unit 5 which includes a gear housing 6 and a carrier 8 supported in the gear housing 6 by means of a ball bearing 7. The carrier 8 is disposed over a pinion gear 9 connected to an output shaft 4 of the motor 3. Moreover, a plurality of epicyclic gears 10 on the carrier 8 are in mesh with the pinion gear 9. A spindle 11 protrudes from the front portion of the carrier 8 coaxially with the output shaft 4 of the motor 3. Reference numeral 12 designates an internal gear for the epicyclic gears 10. The internal gear 12 is secured to the inner surface of the gear housing 6.

Provided forward of the spindle 11 are a hammer 13 and an anvil 19 connected coaxially to the hammer 13. These two elements 13 and 19 couple the spindle 11 to a hydraulic unit 23 (described in further detail below). The spindle 11 penetrates the hammer 13 with its top end loosely inserted in a closed-end bore 20 formed in the anvil 19. A pair of axial grooves 14 are formed in the inner surface of the hammer 13 extending rearward from the forward end of the hammer 13. A pair of generally V-shaped cam grooves 15 are formed in the outer surface of the spindle 11 with the bend of each V-shape pointing to the forward direction. As illustrated, the axial grooves 14 are located generally adjacent to the cam grooves 15 (i.e., the axial grooves 14 generally oppose the cam grooves 15) so as to accommodate one ball 16 in the space between each axial groove 14 and the adjacent V-shaped groove 14. Reference numeral 17 designates a coil spring fitted between the hammer 13 and the carrier 8 so as to bias the hammer 13 in the forward direction.

In addition, a pair of engaging recesses 18 are provided in the front end of the hammer 13, and a pair of matching engaging teeth 21 that fit in the engaging recesses 18 are provided at the rear end of the anvil 19. The hammer 13 and the anvil 19 are coupled together by the biasing force of the coil spring 17 such that the two elements 13 and 19 are integrally rotatable during all phases of operation of the tool. Reference numeral 22 designates a ball which is disposed at the bottom of the closed-end bore 20 and abuts the top end of the spindle 11 for reducing the friction of the spindle 11 at its top end.

A hydraulic impulse generator such as the aforementioned hydraulic unit 23 is coaxially provided forward of and integrally connected with the anvil 19. The hydraulic unit 23 includes a main body 24 securely coupled to the anvil 19. The unit 23 further includes an output shaft 25 protruding forward from the top end of the main body 24. During operation, the main body 24 and the output shaft 25 integrally rotate up to a predetermined level of torque. When a load exceeding the predetermined level of torque is applied to the output shaft 25, a discrepancy between the rotational speeds of the main body 24 and the output shaft 25 develops. Subsequently, the hydraulic pressure accumulated in the working fluid inside the main body 24 of the hydraulic unit 23 translates into high torque transmitted to the output shaft 25. The operating principle and the structure of such a hydraulic unit is well known to those with ordinary skill in the art to which the invention pertains. The output shaft 25 of the hydraulic unit 23 is supported by a ball bearing 25 at its base and protrudes forward from the housing 2. Furthermore, a chuck 27 is mounted on the top end of the output shaft 25 for attachment of a tool bit to the top end of the shaft 25.

In the hydraulic impulse screwdriver 1 thus constructed, when the hammer 13 is biased toward the anvil 19 to its forward position as shown in FIG. 1, the balls 16 are located at the rear ends of the respective axial grooves 14 and at the top ends (the bends) of the respective V-shaped cam grooves 15. Accordingly, the spindle 11 is connected to the hammer 13 by means of the balls 16 so as to be integrally rotatable with the hammer 13. The spindle 11 is also integrally rotatable with the hydraulic unit 23 via the anvil 19. When the motor 3 is activated, the epicycle reduction unit 5 reduces the speed of the torque produced by the motor 3. The torque of the motor 3 then rotates the spindle 11, and thus the hammer 13, the anvil 19, and the hydraulic unit 23 in the clockwise direction as seen from the rear of the tool 1. This subsequently rotates the tool bit attached to the output shaft 25 also in the clockwise direction, thus performing a task, such as tightening of a screw.

As tightening of the screw proceeds, the load on the output shaft 25 increases, such that the rotational speed of the output shaft 25 of the hydraulic unit 23 becomes lower than that of the main body 24. The hydraulic unit 23 then generates impulse force (hydraulic impulses), which is intermittently transmitted as impulses to the output shaft 25, thus allowing additional tightening of the screw.

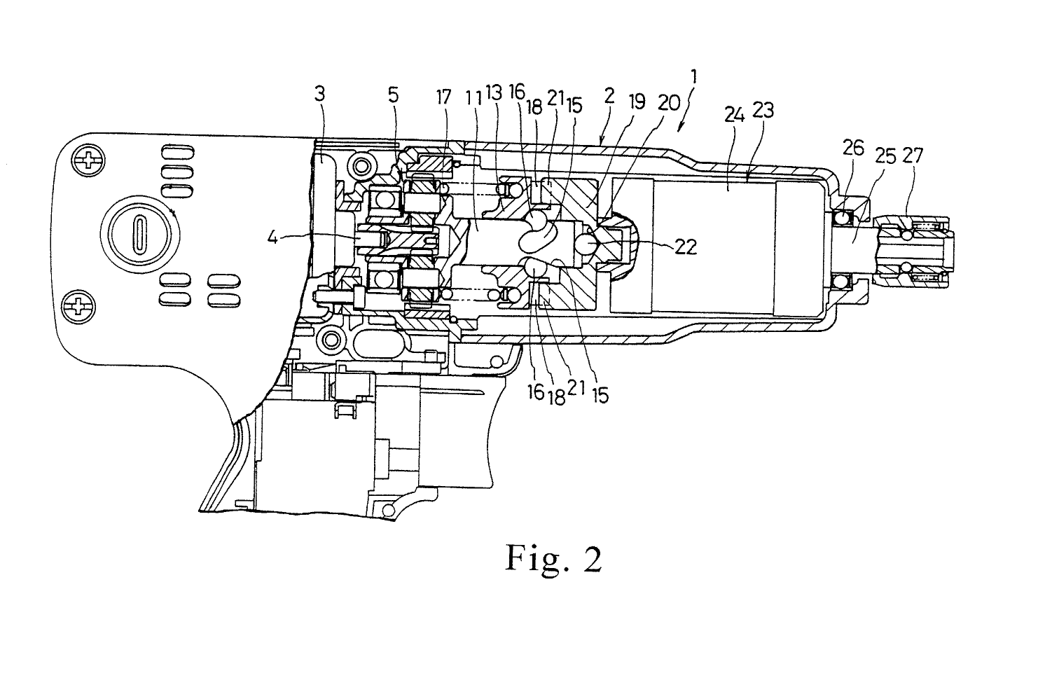

Upon generation of such a hydraulic impulse, a difference in speed develops between the spindle 11, which tends to rotate at the same speed, and the main body 24, the hammer 13, and the anvil 19, which tend to rotate more slowly with the output shaft 25 now operating at a reduced rotational speed. As shown in FIG. 2, each ball 16 moves rearward along one of the slanted groove portions of the cam groove 15, thus pushing the hammer 13 in the rearward direction against the biasing force of the coil spring 17. This permits free rotation of the spindle 11 so as to eliminate the aforementioned difference in rotational speed. When the difference is eliminated upon generation of a hydraulic impulse, the biasing force of the coil spring 17 moves the hammer 13 forward while the balls 16 are restored to the positions shown in FIG. 1, i.e., the top ends of the respective cam grooves 15. When the hammer 13 moves forward with the balls 16, torque acting in the rotational direction of the spindle 11 develops in the hammer 13 and the anvil 19. This torque is subsequently transmitted to the hydraulic unit 23.

Accordingly, the hammer 13 makes reciprocating motion as shown in the illustrated stroke at each occurrence of a hydraulic impulse. The axial lengths of the engaging recesses 18 and the engaging teeth 21 are selected so as to maintain their mutual engagement, such that the spindle 11 remains interlocked with the hydraulic unit 23 regardless of the axial position of the hammer 13. The lead and the length of the slanted groove portions of each cam groove 15 are selected such that the ball 16 does not reach the rearmost end of the cam groove 15 when the hammer 13 is at its rearmost position. It should be noted that when the rotational direction of the motor 3 is reversed, the spindle 11 likewise rotates in the opposite direction with each ball 16 moving along the other slanted groove portion.

As seen from the above, according to this embodiment, the retraction of the hammer 13 and the free rotation of the spindle 11 cushion the impact upon generation of hydraulic impulse, thereby preventing transmission of recoil to the epicycle reduction unit 5 and the motor 3. This minimizes wear on the gears and prevents burning out of the motor 3 as well as improving the comfort experienced in holding the hydraulic impulse screwdriver 1. In addition, as the impact stored as energy in the coil spring 17 can be released in a timely manner, the output torque increases at the occurrence of a hydraulic impulse so as to enhance the energy efficiency of the tool and thus reduces the power consumption. The cushioning/buffer mechanism (including the cam grooves 15 and the balls 16) is provided between the spindle 11 and the hammer 13 in the rear of the hydraulic unit 23, unlike in a conventional apparatus in which an internal gear constitutes part of the buffer mechanism. One advantage of this arrangement is that the lead and/or the length of the cam groove 15 can be easily adjusted, thus increasing the flexibility in setting the degree of shock absorbing effect.

Second Embodiment

An alternate structure is described hereinafter with reference to the attached drawings, in which identical or similar reference numerals or characters denote identical or similar parts or elements throughout the several views. Therefore, description of such elements is omitted.

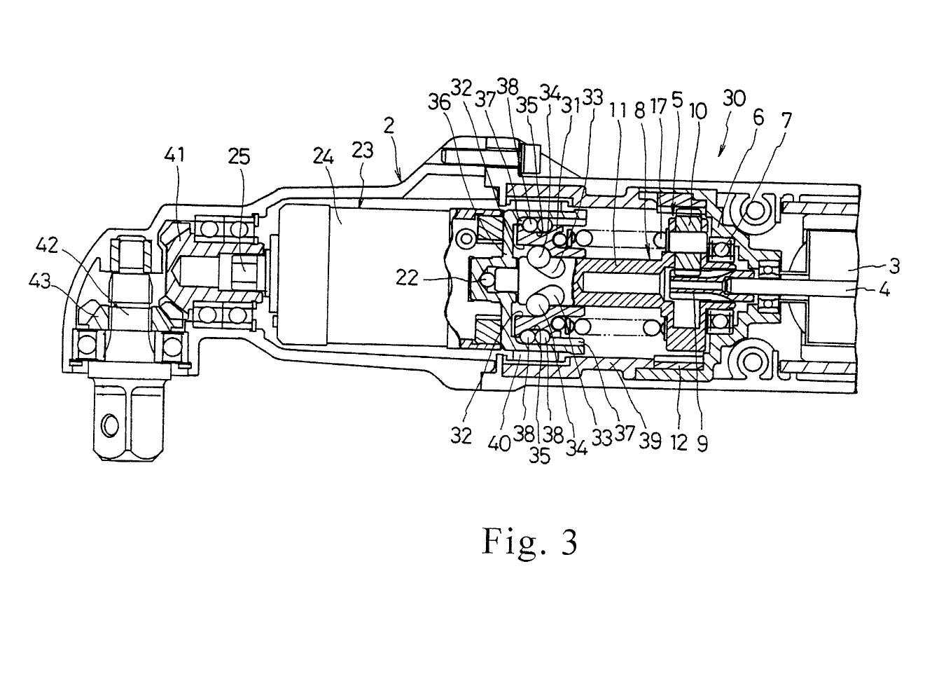

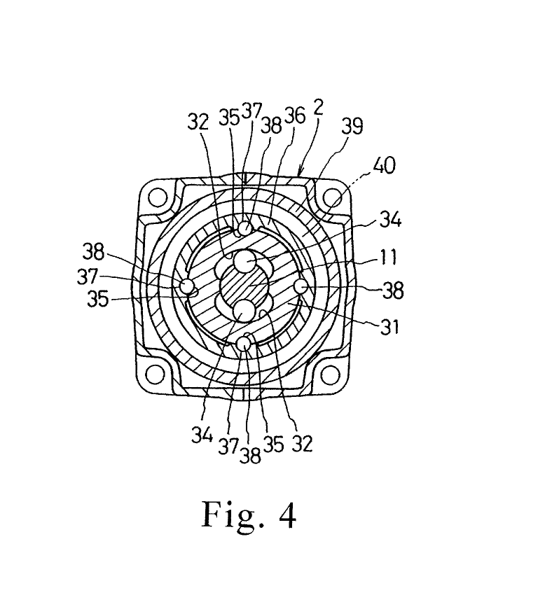

FIG. 3 shows a partially cross-sectional side elevation of an essential part of a hydraulic impulse angle wrench 30 in accordance with the present invention, shown with part of its casing removed to expose internal mechanisms. In this apparatus, the components from the motor 3 to the spindle 11 are identical with those in the first embodiment; for example, the hammer 31 is also coupled to the spindle 11 by means of the balls 34 fitted between the axial grooves 32 in the hammer 13 and the cam grooves 33 in the spindle 11. In this embodiment, however, the hammer 31 is loosely inserted into the cylindrical anvil 36 from the rear of the anvil (the left of FIG. 3 is referred to as the front in the second embodiment). As shown in FIG. 4, the hammer 13 includes a plurality of recesses 35 axially extending in the outer side surface thereof, whereas the anvil 36 includes a plurality of grooves 37 axially extending from its rear end in the inner side surface thereof. The hammer 13 is coupled to the anvil 36 with a plurality of balls 38 fitted between the recesses 35 and the grooves 37 in such a manner as to allow integral rotation of the hammer 13 and the anvil 36 and axial slide of the hammer relative to the anvil. The anvil 36 is supported by a needle bearing 40 within a sleeve 39 which is inserted in the housing 2. In this embodiment, the output shaft 25 of the hydraulic unit 23 is connected to a bevel gear 41. At its top end, the bevel gear 41 engages another bevel gear 43 oriented at a right angle. As the second bevel gear 43 is integrally formed with a spindle 42 supported at the output end of the wrench 30, the torque from the motor 3 is output orthogonally.

In the hydraulic impulse angle wrench 30 thus constructed, when the hammer 31 is biased toward the anvil 36 to its forward position as shown in FIG. 3, the spindle 11 is connected to the hammer 31 by means of the balls 34 so as to be integrally rotatable with the hammer 31. The spindle 11 is also rotatable with the hydraulic unit 23 via the anvil 36. When activated, the motor 3 rotates the spindle 11, the hammer 31, the anvil 36, and the hydraulic unit 23 via the epicycle reduction unit 5 in the clockwise direction facing forward, thus rotating the output shaft 25 and the spindle 42 via the bevel gears 41 and 43.

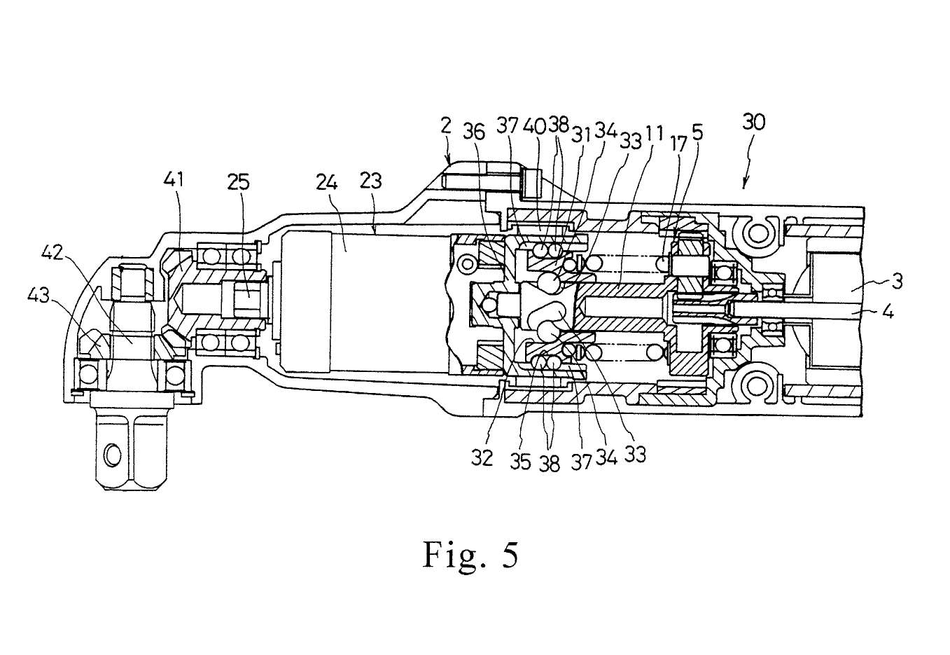

As shown in FIG. 5, when the load on the spindle 42 increases to the point where the hydraulic unit 23 generates hydraulic impulses, each ball 34 moves rearward along one of the slanted groove portions of the cam groove 33, thus pushing the hammer 31 in the rearward direction against the biasing force of the coil spring 17. This in turn permits free rotation of the spindle 11 and absorbs the impact as in the apparatus of the first embodiment. Furthermore, as in the first embodiment, additional torque is generated during the forward movement of the hammer 31, thus augmenting the output torque of the hydraulic unit 23.

Accordingly, according to the second embodiment, the retraction of the hammer 31 and the free rotation of the spindle 11 cushion the impact during generation of hydraulic impulse, thereby preventing transmission of recoil to the epicycle reduction unit 5 and the motor 3. This minimizes wear on the gears and prevents burning out of the motor 3, resulting in improved durability and comfort experienced in holding the hydraulic impulse screwdriver 1. Other advantages include, as in the previous embodiment, increased output torque, reduced power consumption, and greater flexibility in setting the degree of shock absorbing effect.

Particularly in the second embodiment, as the hammer 31 is coupled to the anvil 36 with the balls 38, the hammer 31 slide in the axial direction more smoothly during generation of hydraulic impulses. Additionally, as the anvil 36 is supported by the needle bearing 40 within the housing 2, smooth operation is ensured with virtually no axial runout occurring in the hammer 32 or the anvil 36.

In the foregoing first and second embodiments, a combination of a hammer and an anvil is employed as the means of coupling the spindle 11 of the epicycle reduction unit 5 to the hydraulic unit. It is also possible to couple the hammer directly to the hydraulic unit by eliminating the anvil. In that case, however, the hammer needs to be slidable relative to the main body of the hydraulic unit by means of a key-groove connection or a spline connection. In the two embodiments, the cam grooves are provided in the outer surface of the spindle 11 of the epicycle reduction unit 5. The same effect can be obtained even if these grooves are provided in the inner surface of the hammer, as long as the orientation of the grooves is reversed such that the V-shaped bend of each cam groove points rearward.

In addition, according to the second embodiment, the hammer is loosely inserted into the anvil. Conversely, the hammer may be disposed over the anvil to obtain the same effect. Furthermore, in the second embodiment, the anvil is supported by a needle bearing. If the anvil is omitted, or if the manner of coupling of the hammer with the anvil allows it, the hammer can be supported by a needle bearing or other suitable structure.

Equivalents

It will thus be seen that the present invention efficiently attains the objects set forth above, among those made apparent from the preceding description. As other elements may be modified, altered, and changed without departing from the scope or spirit of the essential characteristics of the present invention, it is to be understood that the above embodiments are only an illustration and not restrictive in any sense. The scope or spirit of the present invention is limited only by the terms of the appended claims.

Having described the invention, what is claimed as new and desired to be secured by Letters Patent is:

1. A hydraulic impulse rotary tool comprising:
a housing;
a motor encased within the housing for generating torque;
a reduction unit with a coaxial spindle, the reduction unit being encased within the housing and adapted for receiving the torque of the motor;
a hydraulic impulse generator encased within the housing and disposed coaxially with and forward of the reduction unit, the hydraulic impulse generator receiving the torque from the spindle;
a coupler disposed between the spindle and the hydraulic impulse generator in such a manner as to be coaxially rotatable with the hydraulic impulse generator and movable in the axial direction, the spindle being loosely inserted into the coupler;
means for biasing the coupler toward the hydraulic impulse generator; and
a plurality of balls fitted in both an outer surface of the spindle and an inner surface of the coupler, one of the outer surface and the inner surface including a plurality of cam grooves therein where the balls are fitted in, the cam grooves being slanted relative to the axis of the spindle,
wherein when a difference in rotational speed develops between the spindle and the coupler, the balls are moved along the respective cam grooves so as to enable rearward movement of the coupler and free rotation of the spindle.

2. A hydraulic impulse rotary tool in accordance with claim 1, wherein the coupler includes a hammer and an anvil coaxial with the hammer, the hammer being penetrated by the spindle and provided between the motor and the anvil, and the anvil being provided between the hammer and the hydraulic impulse generator and firmly secured on one end thereof to the hydraulic impulse generator,
the rotary tool further comprising means for engaging the hammer with the anvil in such a manner as to allow axial sliding motion of the hammer relative to the anvil without disengagement from the anvil and to further allow integral rotation of the hammer with the anvil regardless of the slide position of the hammer.

3. A hydraulic impulse rotary tool in accordance with claim 2, wherein the cam grooves are provided in the spindle and wherein a plurality of axial grooves is provided in the hammer, each axial groove generally opposing one cam groove such that one of the balls is accommodated in the space defined between a cam groove and the opposing axial groove.

4. A hydraulic impulse rotary tool in accordance with claim 3, wherein the rotary tool has two cam grooves, each groove being generally V-shaped with a bend and two slanted groove portions, and with the bend pointing to the hydraulic impulse generator.

5. A hydraulic impulse rotary tool in accordance with claim 4, wherein the balls are located at the bends of the respective V-shaped cam grooves while the spindle and the coupler are rotating in the same speed, and when a difference in rotational speed develops between the spindle and the coupler, the balls are moved along one of the slanted groove portions away from the bends so as to allow rearward movement of the hammer and free rotation of the spindle, and further wherein when the difference rotational in speed is eliminated, the biasing force of the means for biasing moves forward the hammer and restores the balls to the respective bends, thus augmenting the torque of the motor.

6. A hydraulic impulse rotary tool in accordance with claim 5, wherein the means for biasing is a coil spring disposed between the reduction unit and the hammer for biasing the hammer toward the anvil and the hydraulic impulse generator.

7. A hydraulic impulse rotary tool in accordance with claim 1, wherein the coupler is rotatably supported within the housing.

8. A hydraulic impulse rotary tool in accordance with claim 7 further comprising a needle bearing for rotatably supporting the coupler within the housing.

9. A hydraulic impulse rotary tool in accordance with claim 7, wherein the coupler includes an anvil having a generally cylindrical shape with an opening facing the motor and a hammer inserted into the anvil through the opening.

10. A hydraulic impulse rotary tool in accordance with claim 9, where in the anvil includes a plurality of grooves axially extending in an inner surface thereof and the hammer includes a plurality of recesses axially extending in an outer surface thereof and generally opposing the inner surface of the anvil so as to define a plurality hollow spaces therebetween, the rotary tool further comprising at least one ball fitted in each hollow space so as to allow axial slide of the hammer relative to the anvil and integral rotation of the hammer with the anvil regardless of the slide position of the hammer.

11. A hydraulic impulse rotary tool in accordance with claim 1 or 7, wherein the hydraulic impulse rotary tool is one of a hydraulic impulse screwdriver and a hydraulic impulse angle wrench.
